(19) United States
(12) Patent Application Publication
(10) Pub. No.: US 2022/0242172 A1
(43) Pub. Date: Aug. 4, 2022

(54) PNEUMATIC TIRE

(71) Applicant: The Yokohama Rubber Co., LTD., Tokyo (JP)

(72) Inventor: Kenta HOMMA, Kanagawa (JP)

(21) Appl. No.: 17/595,538

(22) PCT Filed: May 22, 2020
(86) PCT No.: PCT/JP2020/020288

§ 371 Date: Nov. 18, 2021

(30) Foreign Application Priority Data
May 27, 2019 (JP) 2019-098661

(51) Int. Cl. B60C 11/13; B60C 11/03

(52) U.S. Cl. CPC B60C 11/1307; B60C 11/0304; B60C 2011/1361; B60C 2011/1338; B60C 11/1353

(57) ABSTRACT

Provided is a pneumatic tire including a tread portion having a ground contact surface configured to contact a road surface. The tread portion includes at least one groove that opens to the ground contact surface. The groove includes a projecting region provided with a plurality of fine projections that project from a groove wall surface facing space within the groove so as to be distributed in a point manner. A ratio H/L1 of a projection height H of the fine projection from the groove wall surface and a groove depth L1 of the groove from the ground contact surface is from 0.01 to 0.09. A ratio W/L2 of a width W of the fine projection orthogonal to a projection direction of the fine projection and a groove width L2 of the groove is from 0.002 to 0.02.

### TECHNICAL FIELD

The present technology relates to a pneumatic tire having a groove in a tread portion.

### BACKGROUND ART

A pneumatic tire may have a tread pattern including a plurality of main grooves extending in a tire circumferential direction in a tread portion and a plurality of lug grooves extending in a tire width direction in a land portion to ensure drainage performance on wet road surfaces. A pneumatic tire with such a tread pattern can ensure drainage performance and improve steering stability on wet road surfaces.

However, in a configuration in which the tread portion includes the main grooves or lug grooves, noise is generated by air flow through the grooves on a ground contact surface, and noise performance is easily degraded. On the other hand, in a configuration in which a groove volume of the main grooves or lug grooves is reduced to suppress degradation in noise performance, drainage performance declines. Thus, drainage performance and noise performance have a negative correlation.

In the related art, there is known a pneumatic tire that includes a plurality of longitudinal grooves extending in a tire circumferential direction on a tire tread surface, wherein projections of different heights are provided on a groove bottom of the longitudinal groove in a pattern of repeated unevenness along the tire circumferential direction (see Japan Unexamined Patent Publication No. 2002-211210). A tire according to Japan Unexamined Patent Publication No. 2002-211210 can have an effect with respect not only to air column resonance but also to noise caused by pumping action, thus reducing vehicle external noise of a tire.

In a pneumatic tire according to Japan Unexamined Patent Publication No. 2002-211210, large projections are required to be provided in grooves to have the effects described above. Thus, a groove volume of the grooves provided in a tread portion is greatly reduced, drainage performance cannot be ensured, and thus wet performance deteriorates.

### SUMMARY

The present technology improves noise performance without impairing drainage performance in a pneumatic tire having grooves in a tread portion.

A pneumatic tire according to an aspect of the present technology, the pneumatic tire including a tread portion including a ground contact surface configured to contact a road surface. The tread portion includes at least one groove that opens to the ground contact surface, the groove includes a projecting region provided with a plurality of fine projections that are distributed and disposed in a point manner on a groove wall surface that contacts a space within the groove, and project from the groove wall surface, a ratio H/L1 of a projection height H of the fine projection from the groove wall surface and a groove depth L1 of the groove from the ground contact surface is from 0.01 to 0.09, and a ratio W/L2 of a width W of the fine projection orthogonal to a projection direction of the fine projection and a groove width L2 of the groove is from 0.002 to 0.02.

A ratio H/W of the projection height H to the width W is preferably from 0.3 to 30.

The fine projection has a substantially frustum shape in which an area of a cross-section of the fine projection orthogonal to the projection direction decreases away from the groove wall surface, and a ratio S1/S2 of an area S1 of the cross-section at a tip of the fine projection to an area S2 of the cross-section of the fine projection along the groove wall surface is preferably from 0.01 to 0.8.

A protrusion area ratio of a total of the areas of the cross-sections of the fine projections along the groove wall surface with respect to an area of the projecting region along the groove wall surface is preferably from 0.1 to 1.0.

A density of the fine projections in the projecting region is preferably 5 or greater per 1 mm² of the projecting region.

The projecting region preferably includes a plurality of regions that differ in the density.

The plurality of regions are preferably disposed along a groove depth direction of the groove such that the deeper a position of a region is in the groove depth direction, the larger the density is.

The groove includes a plurality of circumferential main grooves extending in a tire circumferential direction, and the projecting region is preferably provided at least in the circumferential main groove located in a center region that is 40% of a tire width direction length of the ground contact surface on both sides of a tire centerline in the tire width direction.

The projecting region is preferably provided at least on a surface of a groove bottom of the groove wall surface.

The fine projections are preferably distributed and disposed on the groove wall surface so as to form a plurality of rows extending in a direction intersecting an extension direction of a boundary between the ground contact surface and the groove wall surface.

According to the aspect described above, in the pneumatic tire having the grooves in the tread portion, noise performance can be improved without impairing drainage performance.

### BRIEF DESCRIPTION OF DRAWINGS

FIG. 1 is a tire cross-sectional view illustrating a cross-section of a pneumatic tire of the present embodiment.

FIG. 2 is a diagram illustrating an example of a tread pattern applied to the pneumatic tire in FIG. 1.

FIG. 3 is a diagram illustrating an example of a projecting region.

FIG. 4A is a diagram for explaining a relationship between a projection height of a fine projection and a groove depth of a groove, and FIG. 4B is a diagram for explaining a relationship between a width of the fine projection and a groove width of the groove.

FIG. 5 is a diagram illustrating a modified example of the projecting region.

FIG. 6 is a diagram illustrating a modified example of the projecting region.

FIG. 7 is a diagram illustrating a form of the fine projections.

### DETAILED DESCRIPTION

Hereinafter, a pneumatic tire of the present embodiment will be described in detail. The present embodiment includes various embodiments described below.

### Overall Description of Tire

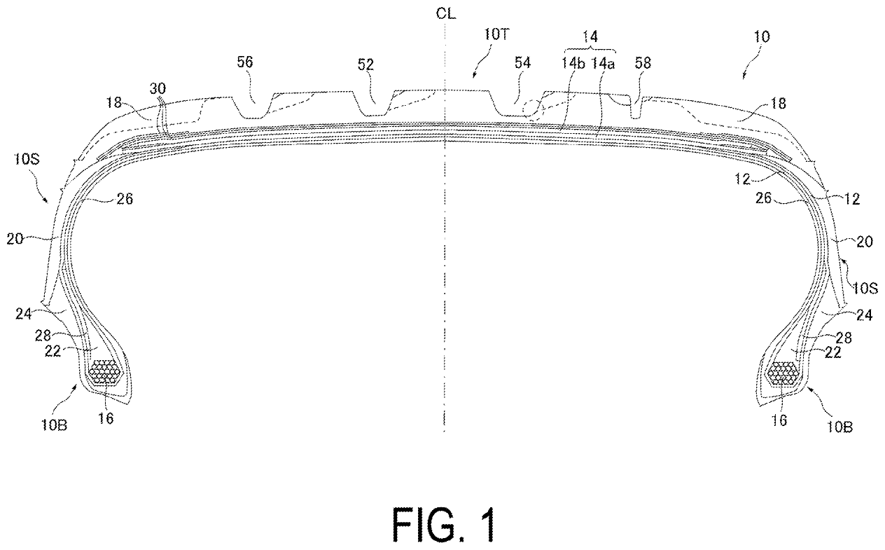

FIG. 1 is a tire cross-sectional view illustrating a cross-section of a pneumatic tire (hereinafter referred to as “tire”) 10 of the present embodiment along a tire radial direction.

The tire 10 is, for example, a tire for a passenger vehicle. “Tire for a passenger vehicle” refers to a tire specified in Chapter A of the JATMA YEAR BOOK 2012 (standards of The Japan Automobile Tyre Manufacturers Association, Inc.). The tire can also be a small truck tire specified in Chapter B or a truck tire or bus tire specified in Chapter C.

Hereinafter, “tire width direction” is a direction parallel with a rotation axis of the tire 10. “Outer side in the tire width direction” is a direction in a tire width direction away from a tire centerline CL, which represents a tire equatorial plane. Additionally, “inner side in the tire width direction” is a side closer to the tire centerline CL in the tire width direction. “Tire circumferential direction” is a direction of rotation about the rotation axis of the tire 10. “Tire radial direction” is a direction orthogonal to the rotation axis of the tire 10. “Outer side in the tire radial direction” refers to a side away from the rotation axis. Similarly, “inner side in the tire radial direction” refers to a side closer to the rotation axis.

### Tire Structure

FIG. 1 is a profile cross-sectional view of a tire 10 of the present embodiment. The tire 10 includes a tread portion 10T including a tread pattern, a pair of bead portions 10B, and a pair of side portions 10S provided in both sides of the tread portion 10T and connecting the pair of bead portions 10B with the tread portion 10T.

The tire 10 mainly includes a carcass ply layer 12, a belt layer 14, and a bead core 16 as framework members, and a tread rubber member 18, side rubber members 20, bead filler rubber members 22, rim cushion rubber members 24, and an innerliner rubber member 26 around the framework members.

The carcass ply layer 12 is composed of a carcass ply member that is made of organic fibers coated with rubber and that is wound between a pair of the annular bead cores 16 and formed into a toroidal shape. The carcass ply member is wound around the bead cores 16 and extends to the inner side of a shoulder region of the tread rubber member 18 in the tire radial direction. The belt layer 14 is provided on an outer side of the carcass ply layer 12 in the tire radial direction and is composed of two belt members 14a and 14b. The belt layer 14 is constituted of rubber-covered steel cords. The steel cords are inclined at a predetermined angle of, for example, from 20 to 30 degrees with respect to the tire circumferential direction. A width in the tire width direction of the lower layer belt member 14a is greater than that of the upper layer belt member 14b. The steel cords of the two belt members 14a and 14b are inclined in opposite directions. Accordingly, the belt members 14a and 14b are crossing layers serving to suppress expansion of the carcass ply layer 12 due to inflation air pressure.

The tread rubber member 18 is provided on an outer side of the belt layer 14 in the tire radial direction. The side rubber members 20 are connected to both end portions of the tread rubber member 18, and form the side portions 10S. The rim cushion rubber members 24 are respectively provided at ends on inner sides of the side rubber members 20 in the tire radial direction and come into contact with a rim on which the tire 10 is mountable. The bead filler rubber member 22 is provided on the outer side of the bead core 16 in the tire radial direction so as to be interposed between a portion of the carcass ply layer 12 prior to being wound around the bead core 16 and a wound portion of the carcass ply layer 12 wound around the bead core 16. The innerliner rubber member 26 is provided on the inner surface of the tire 10 facing a tire cavity region that is filled with air and is surrounded by the tire 10 and the rim.

The tire 10 is also provided with a bead stiffener 28 between the carcass ply layer 12 wound around the bead core 16 and the bead filler rubber member 22 and is further provided with three layers of a belt cover layer 30 that is formed of organic fibers covered with rubber and that covers the belt layer 14 from the outer side of the belt layer 14 in the tire radial direction.

The tire 10 has such a tire structure, but the structure of the pneumatic tire according to an embodiment of the present technology is not limited to the tire structure illustrated in FIG. 1.

### Tread Pattern

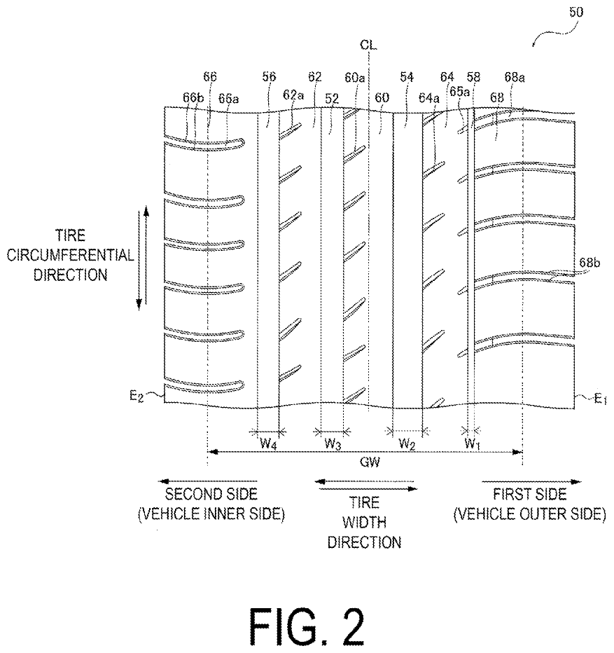

A tread pattern 50 is formed in a region on a tread surface of the tire 10. FIG. 2 is a developed pattern view of an example in which a portion on a tire circumference of the tread pattern 50 formed in the region on the tread surface of the tire 10 illustrated in FIG. 1 is developed on a plane.

The tread pattern 50 includes four circumferential main grooves 52, 54, 56, 58, which extend in the tire circumferential direction and open to a ground contact surface, and five land portions 60, 62, 64, 66, 68, which are defined by the circumferential main grooves 52, 54, 56, 58. Groove center positions of the circumferential main grooves 58, 56, although not particularly limited, may be, for example, away from the tire centerline CL by from 30 to 35% of a tire ground contact width GW in the tire width direction in each of half-tread regions on both sides of the tire centerline CL in the tire width direction. Tire ground contact width GW is a tire width direction length between both ends (ground contact edges) of the tread surface that contacts a ground when the tire 10 mounted on a regular rim, inflated to regular internal pressure, and loaded with 88% of a regular load contacts a horizontal plane. “Regular rim” refers to a “measurement rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). “Regular internal pressure” refers to “maximum air pressure” defined by JATMA, a maximum value in “TIRE LOAD LIMITS AT VARIOUS COLD INFLATION PRESSURES” defined by TRA, or “INFLATION PRESSURES” defined by ETRTO. “Regular load” refers to a “maximum load capacity” defined by JATMA, a maximum value in “TIRE LOAD LIMITS AT VARIOUS COLD INFLATION PRESSURES” defined by TRA, or “LOAD CAPACITY” defined by ETRTO.

The tire centerline CL passes through the region of a land portion 60. The tire centerline CL is interposed between a first side (where the vehicle mounting orientation is on the vehicle inner side) and a second side (where the vehicle mounting orientation is on the vehicle outer side). A half-tread region of the first side includes land portions 64, 68, and a half-tread region of the second side includes land portions 62, 66.

Although the groove center positions of the circumferential main grooves 52, 54 are not particularly limited, in a configuration in which the center positions of the circumferential main grooves 56, 58 are positioned in a range spaced by from 30 to 35% of the tire ground contact width from the tire centerline CL, the groove center positions of the circumferential main grooves 52, 54 are preferably in a range spaced by from 10 to 15% of the tire ground contact width GW from the tire centerline CL interposed therebetween to ensure steering stability by increasing the rib width.

The land portion 60 is a portion which is interposed between the circumferential main groove 52 and the circumferential main groove 54. In the region of the land portion 60, a plurality of lug grooves 60a extending in the tire width direction from the circumferential main groove 52 toward the first side are provided at predetermined intervals in the tire circumferential direction. The lug grooves 60a extend from the circumferential main groove 52 in a direction inclined with respect to the tire width direction and are closed mid-way in the region of the land portion 60 without communicating to the circumferential main groove 54.

A land portion 62 is a portion which is interposed between the circumferential main groove 56 and the circumferential main groove 52. In the region of the land portion 62, a plurality of lug grooves 62a extending in the tire width direction from the circumferential main groove 56 toward the first side are provided at predetermined intervals in the tire circumferential direction. The lug grooves 62a extend from the circumferential main groove 56 in a direction inclined with respect to the tire width direction (the same direction as the inclination direction of the lug grooves 60a), and are closed mid-way in the region of the land portion 62 without communicating to the circumferential main groove 52.

A land portion 64 is a portion which is interposed between the circumferential main groove 54 and the circumferential main groove 58. In the region of the land portion 64, a plurality of lug grooves 64a extending from the circumferential main groove 54 toward the first side in a direction inclined with respect to the tire width direction (the same direction as the inclination direction of the lug grooves 60a) are provided at predetermined intervals in the tire circumferential direction. The lug grooves 64a are closed mid-way in the region of the land portion 64 without communicating to the circumferential main groove 58 from the circumferential main groove 54.

Further, in the region of the land portion 64, a plurality of notches 65a extending from the circumferential main groove 58 toward the second side in a direction inclined with respect to the tire width direction (the direction opposite to the inclination direction of the lug grooves 60a) are provided at predetermined intervals in the tire circumferential direction. The notches 65a are closed mid-way in the region of a land portion 64 without communicating to the circumferential main groove 54 from the circumferential main groove 58.

The inclination angle of the lug grooves 60a, 62a, 64a with respect to the tire width direction is, for example, from 20 to 55 degrees. Chamfers are provided on one side in the tire circumferential direction around the lug grooves 60a, 62a, 64a.

The land portion 66 is provided between the circumferential main groove 56 and a pattern end E2. In the region of the land portion 66, a plurality of shoulder lug grooves 66a are provided at predetermined intervals in the tire circumferential direction. Each of the shoulder lug grooves 66a extends in the tire width direction from the pattern end E2 toward the first side, and is closed mid-way in the region of the land portion 66 without opening to the circumferential main groove 56.

A land portion 68 is provided between the circumferential main groove 58 and a pattern end E₁. In the region of the land portion 68, a plurality of shoulder lug grooves 68a are provided at predetermined intervals in the tire circumferential direction. Each of the shoulder lug grooves 68a extends in the tire width direction from the pattern end E₁ toward the second side, and opens to the circumferential main groove 58. Chamfers 66b, 68b are provided around the shoulder lug grooves 66a, 68a.

The lug grooves 60a, 62a, 64a, the notches 65a, and the shoulder lug grooves 66a, 68a open to the ground contact surface.

When a groove width of the circumferential main groove 58 is W₁, a groove width of the circumferential main groove 54 is W₂, a groove width of the circumferential main groove 52 is W₃, and a groove width of the circumferential main groove 56 is W₄, the groove width W₁ is the smallest of the groove widths W₁ to W₄ and the groove width W₂ is the largest. A ratio W₂/W₁ of the groove width W₁ and the groove width W₂ is preferably from 4 to 5. Furthermore, when a groove area ratio of the region on the first side of the tread pattern 50, as viewed from the tire centerline CL, is Sₒᵤₜ, and a groove area ratio of the region on the second side is Sin, a ratio Sin/Soul is preferably from 1.1 to 1.2.

The groove depths of the circumferential main grooves 52, 54, 56, 58 are each, for example, from 5 to 8.5 mm. The groove widths W₁, W₂, W₃, W₄ of the circumferential main groove 58, 54, 52, 56 are, for example, in this order, from 4.0 to 7.5 mm, from 12 to 18 mm, from 10 to 16 mm, and from 10 to 16 mm.

Although the tread pattern 50 is configured as described above, a tread pattern of a pneumatic tire according to an embodiment of the present technology is not limited to the tread pattern illustrated in FIG. 2.

### Projecting Region

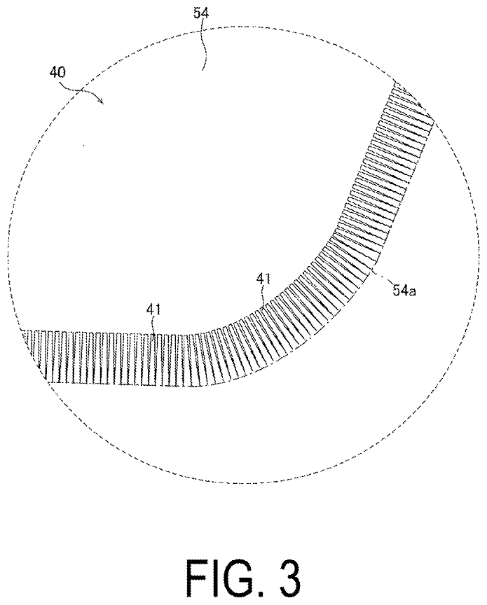

FIG. 3 is a diagram illustrating an example of a projecting region 40 provided in the circumferential main groove 54.

As illustrated in FIG. 3, each of the circumferential main grooves 52, 54, 56, 58 includes the projecting region 40 having a plurality of fine projections 41, which are distributed and disposed in a point manner on a groove wall surface 54a that faces (contacts) a space within the groove and project from the groove wall surface 54a. The groove wall surface includes a pair of sidewall surfaces that face each other across the space within the groove, and a bottom surface between the sidewall surfaces. Note that “bottom surface” refers to a portion of the groove wall surface having an inclination angle in a direction normal to the groove depth direction of less than 40° in a profile cross-section of the tread portion along the tire width direction. FIG. 3 illustrates the fine projections 41 provided on a portion of the groove wall surface of the circumferential main groove 54 (the portion surrounded by a broken line in FIG. 1). In the following description, the fine projections 41 provided in the circumferential main groove 54 are used as an example, whereas the fine projections 41 provided in the circumferential main grooves 52, 56, 58 are preferably configured in the same manner.

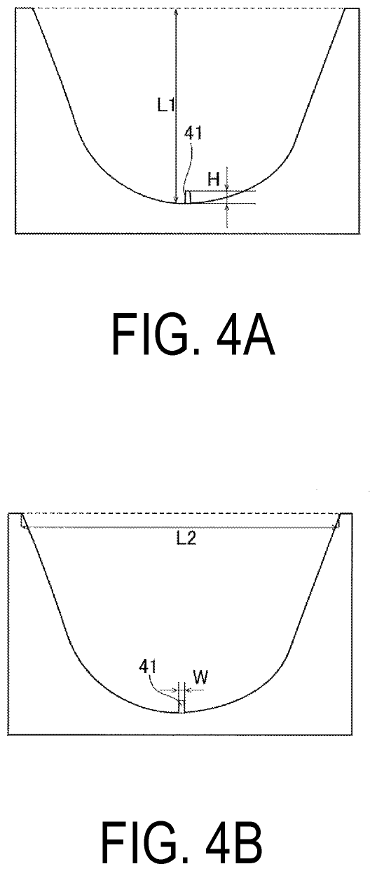

FIG. 4A is a diagram for explaining a relationship between a projection height H of the fine projection 41 from the groove wall surface 54a and a groove depth L1 of the circumferential main groove 54 from the ground contact surface. FIG. 4B is a diagram for explaining a relationship between a width W of the fine projection 41 and a groove width L2 of the circumferential main groove 54. FIGS. 4A-4B illustrate only one fine projection 41 to make the description easier to understand. Additionally, in FIGS. 4A-4B, a cross-sectional shape of the circumferential main groove 54 differs from that illustrated in FIG. 1.

In the present specification, “width W of the fine projection 41” refers to a width of a portion (hereinafter also referred to as “bottom surface”) of the fine projection 41 at the same height as the groove wall surface (along an extension direction of the groove wall surface) along a direction orthogonal to the projection direction of the fine projection 41. “Groove width of a groove provided with a chamfer” refers to a groove width that also includes the chamfer. In a configuration in which a length of the chamfer along the groove width direction changes in an extension direction of the groove, a width of the groove is calculated by taking an average value of lengths of the chamfer as a width of the chamfer. In addition, the width W in a configuration in which the cross-sectional shape of the fine projection 41 is a polygon as described below is expressed by the diameter of a circle having the same area.

According to one embodiment, the bottom surfaces of the fine projections 41 are surrounded by a groove wall surface 54a, whereas according to another embodiment, the bottom surfaces of the fine projections 41 may be in contact with each other.

In the projecting region 40, a ratio H/L1 of the projection height H of the fine projection 41 along the projection direction of the fine projection 41 and the groove depth L1 of the circumferential main groove 54 is from 0.01 to 0.09. Additionally, a ratio W/L2 of the width W of the fine projection 41 along a direction orthogonal to the projection direction and the groove width L2 of the circumferential main groove 54 is from 0.002 to 0.02. An examination by the present inventors revealed that noise performance can be improved without impairing drainage performance by providing the fine projections 41 having such a form. The following effects of the fine projections 41 are considered to contribute to improving noise performance. In other words, in the circumferential main groove 54 provided with the projecting region 40, frictional resistance between air flowing within the circumferential main groove 54 and the fine projections 41 is generated, and a flow speed of air within the circumferential main groove 54 decreases. Thus, air column resonance that amplifies vibration of the circumferential main groove 54 decreases, and noise caused by air column resonance decreases. In other words, noise performance improves. A portion of the energy of the air flowing within the circumferential main groove 54 is converted to thermal energy by collisions between the air and the fine projections 41, and thus the flow speed of the air flowing within the circumferential main groove 54 decreases. On the other hand, a groove volume of the circumferential main groove 54 is hardly reduced because the fine projections 41 are so small as to satisfy the ranges described above by the ratio H/L1 and the ratio W/L2. This ensures drainage performance due to the circumferential main groove 54. In other words, according to the tire 10 of the present embodiment, noise performance can be improved without impairing drainage performance. Thus, steering stability performance on wet road surfaces (wet performance) and noise performance can be improved at the same time.

When the ratio H/L1 is greater than 0.09, a cross-sectional area of a flow path of the circumferential main groove 54 becomes so small that drainage performance is degraded. When the ratio H/L1 is less than 0.01, an area that contacts the air flowing within the circumferential main groove 54 becomes so small that noise cannot be reduced.

When the ratio W/L2 is greater than 0.02, the cross-sectional area of the flow path of the circumferential main groove 54 becomes so small that drainage performance is degraded. When the ratio H/L2 is less than 0.002, the area that contacts the air flowing within the circumferential main groove 54 becomes so small that noise cannot be reduced.

The ratio H/L1 is preferably from 0.025 to 0.0625, and more preferably from 0.035 to 0.05. Furthermore, the ratio W/L2 is preferably from 0.0035 to 0.01, and more preferably from 0.005 to 0.008.

The projection height H of the fine projection 41 is, for example, 0.08 to 0.72 mm, and the width W is, for example, from 0.03 to 0.3 mm. The range of the projection height H and that of the width W are appropriate when a groove depth of the circumferential main groove is from 6 to 8 mm and a groove width thereof is from 5 to 16 mm.

A shape of the fine projections 41 is, for example, that of a pillar, a cone, or a frustum. A shape of a cross-section of the fine projection 41 along the direction orthogonal to the projection direction (hereinafter simply referred to as “cross-section”) is, for example, a circle, an ellipse, or a polygon. The polygon, although preferably a regular polygon, may be a concave polygon with at least one vertex angle greater than 180 degrees such as a Y shape, a cross shape, or a star shape.

According to one embodiment, the projection direction of the fine projection 41 is preferably aligned with respect to the normal line direction of the groove wall surface as illustrated in FIG. 3, whereas according to another embodiment, the projection direction of the fine projection 41 is preferably inclined with respect to the normal direction of the groove wall surface. In the latter case, the inclination angle is, for example, greater than 0° and no greater than 10° with respect to the normal direction of the groove wall surface.

According to one embodiment, the fine projection 41 is preferably not branched in the middle of the projection direction.

According to one embodiment, adjacent fine projections 41 may be disposed at intervals on the groove wall surface, or may be in contact with each other.

The projecting region 40 is formed, for example, by molding the tire 10 on a wall surface of a mold for molding a groove wall surface, using a mold that has been subjected to predetermined processing. Examples of a method for processing the wall surface of the mold include laser machining, which performs marking by irradiating with a laser beam. Another method of forming the projecting region 40 includes a method of applying predetermined processing to a groove wall surface of a molded tire. Examples thereof include laser processing, which irradiates with a laser beam to be focused at a surface of the tire to concentrate light energy, and heats and sublimates rubber around the fine projections 41.

According to one embodiment, the projecting region 40 is preferably provided at least in a circumferential main groove located in a center region that is at least 40% of the tire width direction length of the ground contact surface (ground contact width) on both sides of the tire centerline CL in the tire width direction (a total of 80% of the length). For example, the projecting region 40 is preferably provided at least in the circumferential main grooves 52, 54. This is because the circumferential main grooves 52, 54 are located closer to the tire centerline CL than the circumferential main grooves 56, 58, have longer ground contact lengths, and thus are likely to produce more noise.

Further, according to one embodiment, the projecting region 40 is more preferably provided in all of the circumferential main grooves 52, 54, 56, 58. Thus, noise can be effectively reduced, and noise performance can be improved. A density of the fine projections 41 may vary between the circumferential main grooves, depending on a distance from the tire centerline Cl.

In addition, according to one embodiment, the projecting region 40 is preferably provided in the lug grooves 60a, 62a, 64a, the notches 65a, and the shoulder lug grooves 66a, 68a. In this case as well, noise can be effectively reduced and noise performance can be improved.

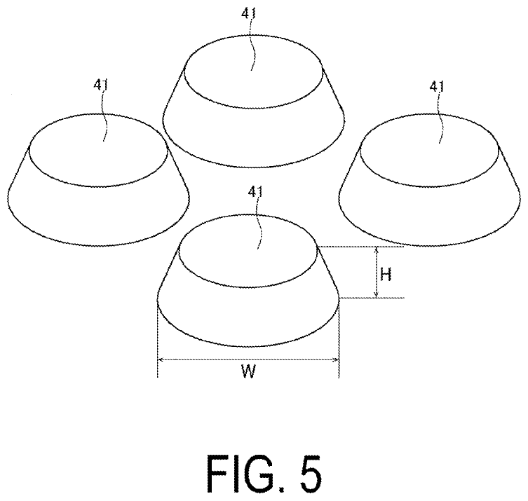

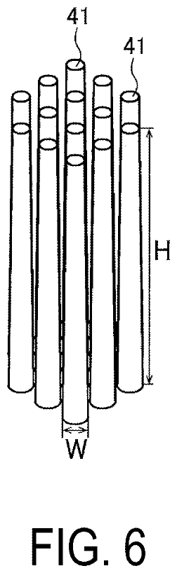

FIGS. 5 and 6 are diagrams illustrating modified examples of the fine projections 41.

The fine projection 41 can take various forms within the ranges of the ratio H/L1 and the ratio W/L2 described above. For example, as illustrated in FIG. 5, a ratio H/W may be one or less, or as illustrated in FIG. 6, the ratio H/W may be greater than 1.

According to one embodiment, the ratio H/W (aspect ratio) of the projection height H to the width W of the groove is preferably from 0.3 to 30. When the ratio H/W is less than 0.3, the height of the fine projection 41 is too small, and an effect of noise reduction may not be obtained. In addition, when the ratio H/W is greater than 30, the width of the fine projection 41 is too small, the fine projection 41 is likely to flex (unlikely to self-stand), and space between the fine projections 41 decreases. Thus, the effect of noise reduction by the air within the groove contacting the fine projections 41 may not be obtained. In addition, as in this case, when a projection height of the fine projections 41 is large, the groove volume decreases, and thus, drainage performance may decline, and wet performance may decline.

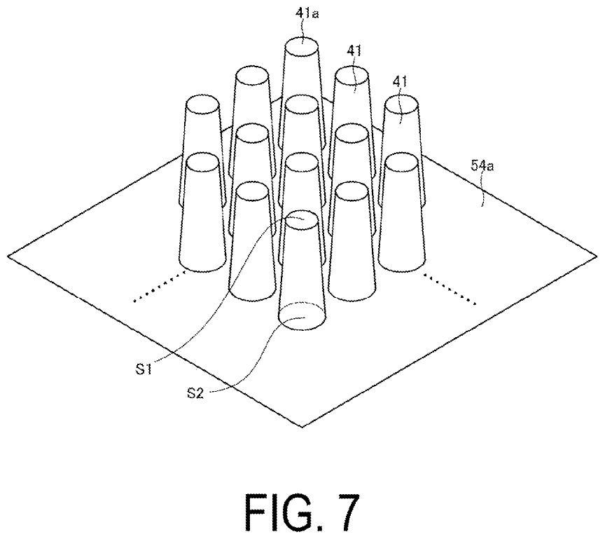

According to one embodiment, the fine projection 41 preferably has a substantially frustum shape in which an area of a cross-section (hereinafter referred to as “cross-sectional area”) of the fine projection 41 decreases away from the groove wall surface. In this case, a ratio S1/S2 of a cross-sectional area S1 of an end surface 41a of the fine projection 41 (see FIG. 7) (cross-sectional area of the tip) with respect to a cross-sectional area S2 of a projection base portion of the fine projection 41 along an extension direction of the groove wall surface (see FIG. 7) is preferably from 0.01 to 0.8. FIG. 7 is a diagram illustrating a configuration of the fine projections 41. When the ratio S1/S2 is less than 0.01, the fine projections 41 having the substantially frustum shape are difficult to make in tread rubber. When the ratio S1/S2 is greater than 0.8, an area of the end surface 41a of the fine projection 41 is too large, and the space between the fine projections 41 decreases. Thus, the effect of noise reduction decreases.

According to one embodiment, as illustrated in FIG. 7, the end surface 41a of the fine projection 41 is preferably a plane parallel to the groove wall surface, but, according to another embodiment, may have a bulging (e.g. rounded) shape in the projection direction. In this case, the cross-sectional area S1 of the end surface 41a can be an area of a cross-section cut in a plane parallel to the groove wall surface at a height position of an upper surface of the substantially frustum shape. “Cross-sectional area S1 of the end surface 41a”, when the end surface 41a of the fine projection 41 is a plane parallel to the groove wall surface, refers to an area of the upper surface of the substantially frustum shape.

According to one embodiment, a protrusion area ratio of a total of the cross-sectional areas of the fine projections 41 along the extension direction of the groove wall surface with respect to the area of the projecting region 40 along the extension direction of the groove wall surface (in-plane direction) is preferably from 0.1 to 1.0. “Area of the projecting region 40” refers to a total area of the projecting region 40 that also includes an area of the bottom surfaces of the fine projections 41. When the protrusion area ratio is within the range described above, the space between the fine projections 41 is not too wide but appropriately wide, and the effect of noise reduction increases. The protrusion area ratio is preferably an average value of a plurality of protrusion area ratios determined for portions of the projecting region 40 provided with a plurality (e.g. from 2 to 10) of the fine projections 41. When the protrusion area ratio is less than 0.1, a volume of the fine projections 41 within the space inside the groove is small, and the effect of noise reduction is likely to be insufficient. When the protrusion area ratio is greater than 1.0, the fine projections 41 are difficult to make. The protrusion area ratio preferably ranges from 0.5 to 1.0. The fine projections 41 may be disposed such that bottom surfaces of adjacent fine projections 41 partly overlap with each other.

According to one embodiment, a density of the fine projections 41 in the projecting region 40 is preferably 5 or greater per 1 mm² of the projecting region 40. The density of the fine projections 41 can be calculated, for example, as an average value of the densities of the fine projections 41 in a plurality (e.g. from 2 to 10 locations) of measured regions (e.g. 1 mm² regions) in the projecting region 40. When the density of the fine projections 41 is less than 5 per 1 mm², the number of the fine projections 41 is too small, and the effect of noise reduction is likely to be insufficient. On the other hand, the density of the fine projections 41 is preferably 100 or less per 1 mm² of the projecting region 40, and more preferably 20 or less. This secures the space between the fine projections 41, and facilitates the effect of noise reduction.

According to yet another of such an embodiment, the projecting region 40 preferably includes a plurality of regions with different densities of the fine projections 41. Thus, a contact area, in which the air contacts the fine projections within the groove, changes within the groove and is non-uniform, and the effect of noise reduction increases. The number of the plurality of regions having different densities is two or more, and according to one embodiment, the projecting region 40 is preferably configured such that a large number (e.g. 10 or more) of regions that are slightly different in density are juxtaposed to continuously change in density. Among the plurality of regions, the ratio of the density of the region of highest density to the density of the region of lowest density is, for example, from 1.3 to 10.

According to yet another of such an embodiment, the plurality of regions having different densities of the fine projections 41 are preferably disposed along the groove depth direction of the groove such that the deeper a region is in the groove depth direction, the larger the density of the fine projections 41 in the region is. This configuration enhances the effect of noise reduction.

The projecting region 40 is provided at least on a portion of the groove wall surface.

According to one embodiment, the projecting region 40 is preferably provided at least in a region of the groove wall surface in a profile cross-section along the tire width direction. For example, the projecting region 40 is preferably provided at least on the bottom surface of the groove wall surface. In the profile cross-section, the bottom surface of the groove wall surface has a smaller amount of deformation when grounded compared to the side wall surface inclined with respect to an extension direction of the bottom surface, and thus, the effect of reducing the flow speed due to contact with the air flowing within the groove is great. According to one embodiment, the projecting region 40 is preferably provided in all regions of the groove wall surface in the profile cross-section.

Additionally, according to one embodiment, the projecting region 40 is preferably provided at least in a region of the groove wall surface along the extension direction of the groove. For example, the projecting region 40 is preferably provided at least in a region along the extension direction of the groove, and is preferably provided in all regions of the extension direction of the groove. On the other hand, the projecting region 40 may be interrupted, for example, in a region along the extension direction of the groove, and may be, for example, intermittently provided so as to be interrupted in a plurality of regions.

When the groove has a chamfer, the projecting region 40 is preferably formed in a chamfered surface as well.

According to one embodiment, the fine projections 41 are preferably distributed and disposed on the groove wall surface so as to form a plurality of rows extending in a direction intersecting an extension direction of a boundary between the ground contact surface and the groove wall surface (edge of a land portion). The plurality of rows preferably extend in a direction parallel to each other. Adjacent intervals of the fine projections 41 constituting the rows are less than or equal to adjacent intervals of the rows. Such a configuration of the fine projections 41 produces an effect of smoothly discharging water in the groove to the outside, and improves drainage properties. Further, according to one embodiment, the fine projections 41 are more preferably disposed in rows in a direction orthogonal to the boundary. Examples of such an aspect of a disposition of the fine projections 41 include an aspect in which the fine projections 41 are disposed at lattice points of a lattice (equilateral triangular lattice) that is made of equilateral triangles on the groove wall surface. Example, Comparative Example, and Conventional Example

To confirm the effects of the present technology, four tires having a tire size of 205/55R16 were manufactured for each of Examples, Comparative Examples, and Conventional Example described below. The tires were mounted on a front wheel drive passenger car having an engine displacement of 2 L, which was used as a test vehicle, and were examined for noise performance and wet performance. The vehicle has a rim size of 16×6.5J, and the air pressure is 210 kPa.

The tires according to Conventional Example, Comparative Examples 1 to 4, and Examples 1 to 6 have tire structures illustrated in FIG. 1 except for the points shown in Table 1 and Table 2 and the following description, and basically have the tread pattern 50 illustrated in FIG. 2.

In each of Comparative Examples 1 to 4 and Examples 1 to 6, a projecting region was provided in all regions of the groove wall surfaces (including chamfered surfaces) of the circumferential main grooves 52, 54, 56, 58, the lug grooves 60a, 62a, 64a, the notches 65a, and the shoulder lug grooves 66a, 68a.

Conventional Example was the same as Example 1 except that a projecting region was not provided.

In each of Comparative Examples 1 to 4 and Examples 1 to 6, the projection direction of the fine projections was aligned with the normal direction of the groove wall surface. Note that in Conventional Example, Comparative Examples 1 to 4, and Examples 1 to 6, the groove depth L1 of the circumferential main groove 54 was 8 mm, and the groove width L2 was 14 mm.

In Table 1 and Table 2, “presence of density difference” refers to whether a projecting region has a plurality of regions having different densities of fine projections per 1 mm² of the projecting region.

In Example 5, the plurality of regions having different densities were provided in the circumferential main grooves 52, 54, 56, 58 in the tread portion so as to differ in density in the tire circumferential direction. Specifically, two types of regions having different densities in the tire circumferential direction were alternately provided so that there were regions of different densities constantly in the ground contact surface. The ratio of the density of the region of highest density to the density of the region of lowest density was set within the range of 1.3 to 10.

In Example 6, the plurality of regions having different densities in the depth direction were provided in all of the circumferential main grooves, lug grooves, notches, and shoulder lug grooves in the tread portion. Specifically, the density was varied between the side wall surface of the groove wall surface and the bottom surface thereof. The ratio of the density of the region of highest density to the density of the region of lowest density was set within the range of 1.3 to 10.

“Protrusion area ratio” shown in Table 1 refers to an average value of protrusion area ratios determined for ten fine projections randomly selected in a projecting region.

“Density” shown in Table 1 and Table 2 refers to an average of densities in ten 1 mm² measured regions randomly selected in a projecting region.

### Wet Performance

Each test tire was mounted on a test vehicle, and sensory evaluation was performed for, among other things, steering characteristics and straightness when a test driver traveled within the range of from 0 to 80 km/h on a test course of wet road surfaces having a water depth of 3 mm. The results are expressed as index values with Comparative Example 1 being assigned the value of 100. Larger index values mean excellent wet performance.

### Noise Performance

Each test tire was mounted on a test vehicle, and pass-by noise outside of the vehicle when traveling at 60 km/h was measured in accordance with European noise regulation conditions (ECE R117). The evaluation results are shown by index values with Conventional Example being assigned the value of 100, using the reciprocals of measured values. Larger index values mean excellent noise performance.

Thus, a case where a wet performance index was 100 or more and a noise performance index was more than 100, was determined to be one in which noise performance can be improved without impairing drainage performance.

TABLE 1-1

| | Conventional | | Comparative | Comparative |
|---|---|---|---|---|
| | Example | Example 1 | Example 1 | Example 2 |
| Presence of projecting | No | Yes | Yes | Yes |
| region | | | | |
| Shape of fine projection | Substantially | Substantially | Substantially | Substantially |
| | cylindrical | cylindrical | cylindrical | cylindrical |
| Height ratio H/L1 | — | 0.0625 | 0.2 | 0.005 |
| Width ratio W/L2 | — | 0.015 | 0.015 | 0.015 |
| Aspect ratio H/W | — | 2.4 | 7.6 | 0.19 |
| Cross-sectional area ratio | — | 1 | 1 | 1 |
| S1/S2 | | | | |
| Protrusion area ratio (%) | — | 40 | 40 | 40 |
| Density (projections/mm²) | — | 4 | 4 | 4 |
| Presence of density | — | No | No | No |
| difference | | | | |
| Presence of density | — | No | No | No |
| difference in depth | | | | |
| direction | | | | |
| Noise performance | 100 | 102 | 102 | 100 |
| Wet performance | 100 | 100 | 97 | 100 |

| | Comparative | Comparative | |
|---|---|---|---|
| | Example 3 | Example 4 | Example 2 |
| Presence of projecting region | Yes | Yes | Yes |
| Shape of fine projection | Substantially | Substantially | Substantially |
| | cylindrical | cylindrical | cylindrical |
| Height ratio H/L1 | 0.0625 | 0.0625 | 0.0625 |
| Width ratio W/L2 | 0.1 | 0.001 | 0.005 |
| Aspect ratio H/W | 0.36 | 36 | 7.1 |
| Cross-sectional area ratio | 1 | 1 | 1 |
| S1/S2 | | | |
| Protrusion area ratio (%) | 40 | 40 | 40 |
| Density (projections/mm²) | Less than 1 | 4 | 4 |
| Presence of density difference | No | No | No |
| Presence of density difference | No | No | No |
| in depth direction | | | |
| Noise performance | 102 | 100 | 103 |
| Wet performance | 95 | 100 | 100 |

TABLE 2

| | Example 3 | Example 4 | Example 5 | Example 6 |
|---|---|---|---|---|
| Presence of | Yes | Yes | Yes | Yes |
| projecting region | | | | |
| Shape of fine | Sub- | Sub- | Sub- | Sub- |
| projection | stantially | stantially | stantially | stantially |
| | frustum | frustum | frustum | frustum |
| Height ratio H/L1 | 0.0625 | 0.0625 | 0.0625 | 0.0625 |
| Width ratio W/L2 | 0.005 | 0.005 | 0.005 | 0.005 |
| Aspect ratio H/W | 7.1 | 7.1 | 7.1 | 7.1 |
| Cross-sectional | 0.4 | 0.4 | 0.4 | 0.4 |
| area ratio S1/S2 | | | | |
| Density | 4 | 10 | 10 | 10 |
| (projections/mm²) | | | | |
| Presence of density | No | No | Yes | Yes |
| difference | | | | |
| Presence of density | No | No | No | Yes |
| difference in depth | | | | |
| direction | | | | |
| Noise performance | 104 | 105 | 107 | 109 |
| Wet performance | 100 | 100 | 100 | 100 |

A comparison of Conventional Example and Example 1 shows that presence of a projecting region in a groove can improve noise performance without impairing drainage performance.

A comparison of Example 1 and Comparative Example 1 shows that a decrease in wet performance can be suppressed when a height ratio H/L1 of the fine projection is 0.09 or less.

A comparison of Example 1 and Comparative Example 2 shows that noise performance improves when the height ratio H/L1 of the fine projection is 0.01 or greater.

A comparison of Example 1 and Comparative Example 3 shows that a decrease in wet performance can be suppressed when a width ratio W/L2 of the fine projection is 0.02 or less.

A comparison of Example 1 and Comparative Example 4 shows that noise performance improves when the width ratio W/L2 of the fine projection is 0.002 or greater.

A comparison of Example 2 and Example 3 shows that noise performance improves further when the cross-sectional area ratio S1/S2 is not greater than 0.8.

A comparison of Example 3 and Example 4 shows that noise performance improves further when the density of the fine projections is 5 or more per 1 mm² of a projecting region.

A comparison of Example 4 and Example 5 yields an unexpected effect that noise performance improves greatly when a projecting region has differences in density.

A comparison between Example 5 and Example 6 shows that noise performance improves greatly when a projecting region has differences in density in the depth direction.

The foregoing has been a detailed description of pneumatic tires according to embodiments of the present technology. However, the present technology is naturally not limited to the above embodiments and Examples, and may be improved or modified in various ways within the scope of the substance of the present technology. A pneumatic tire according to an embodiment of the present technology can be filled with air in a cavity region surrounded by a pneumatic tire and a rim, and can also be filled with a gas other than air (e.g. an inert gas such as nitrogen). Additionally, a pneumatic tire according to an embodiment of the present technology can also be applied to tires other than pneumatic tires such as solid tires and run-flat tires.

1-10. (canceled)

11. A pneumatic tire, comprising:
a tread portion comprising a ground contact surface configured to contact a road surface,
the tread portion comprising at least one groove that opens to the ground contact surface,
the groove comprising a projecting region provided with a plurality of fine projections that are distributed and disposed in a point manner on a groove wall surface that contacts a space within the groove, and project from the groove wall surface,
a ratio H/L1 of a projection height H of the fine projection from the groove wall surface and a groove depth L1 of the groove from the ground contact surface being from 0.01 to 0.09,
and a ratio W/L2 of a width W of the fine projection orthogonal to a projection direction of the fine projection and a groove width L2 of the groove being from 0.002 to 0.02.

12. The pneumatic tire according to claim 11, wherein a ratio H/W of the projection height H to the width W is from 0.3 to 30.

13. The pneumatic tire according to claim 11, wherein the fine projection has a substantially frustum shape in which an area of a cross-section of the fine projection orthogonal to the projection direction decreases away from the groove wall surface, and a ratio S1/S2 of an area S1 of the cross-section at a tip of the fine projection to an area S2 of the cross-section of the fine projection along the groove wall surface is from 0.01 to 0.8.

14. The pneumatic tire according to claim 11, wherein a protrusion area ratio of a total of the areas of cross-sections of the fine projections along the groove wall surface with respect to an area of the projecting region along the groove wall surface is from 0.1 to 1.0.

15. The pneumatic tire according to claim 11, wherein a density of the fine projections in the projecting region is 5 or greater per 1 mm² of the projecting region.

16. The pneumatic tire according to claim 15, wherein the projecting region comprises a plurality of regions that differ in the density.

17. The pneumatic tire according to claim 16, wherein the plurality of regions are disposed along a groove depth direction of the groove such that the deeper a position of a region is in the groove depth direction, the larger the density is.

18. The pneumatic tire according to claim 11, wherein
the groove comprises a plurality of circumferential main grooves extending in a tire circumferential direction, and
the projecting region is provided at least in the circumferential main groove located in a center region that is 40% of a tire width direction length of the ground contact surface on both sides of a tire centerline in the tire width direction.

19. The pneumatic tire according to claim 11, wherein the projecting region is provided at least on a surface of a groove bottom of the groove wall surface.

20. The pneumatic tire according to claim 11, wherein the fine projections are distributed and disposed on the groove wall surface so as to form a plurality of rows extending in a direction intersecting an extension direction of a boundary between the ground contact surface and the groove wall surface.

21. The pneumatic tire according to claim 12, wherein the fine projection has a substantially frustum shape in which an area of a cross-section of the fine projection orthogonal to the projection direction decreases away from the groove wall surface, and a ratio S1/S2 of an area S1 of the cross-section at a tip of the fine projection to an area S2 of the cross-section of the fine projection along the groove wall surface is from 0.01 to 0.8.

22. The pneumatic tire according to claim 21, wherein a protrusion area ratio of a total of the areas of the cross-sections of the fine projections along the groove wall surface with respect to an area of the projecting region along the groove wall surface is from 0.1 to 1.0.

23. The pneumatic tire according to claim 22, wherein a density of the fine projections in the projecting region is 5 or greater per 1 mm² of the projecting region.

24. The pneumatic tire according to claim 23, wherein the projecting region comprises a plurality of regions that differ in the density.

25. The pneumatic tire according to claim 24, wherein the plurality of regions are disposed along a groove depth direction of the groove such that the deeper a position of a region is in the groove depth direction, the larger the density is.

26. The pneumatic tire according to claim 25, wherein
the groove comprises a plurality of circumferential main grooves extending in a tire circumferential direction, and
the projecting region is provided at least in the circumferential main groove located in a center region that is 40% of a tire width direction length of the ground contact surface on both sides of a tire centerline in the tire width direction.

27. The pneumatic tire according to claim 26, wherein the projecting region is provided at least on a surface of a groove bottom of the groove wall surface.

28. The pneumatic tire according to claim 27, wherein the fine projections are distributed and disposed on the groove wall surface so as to form a plurality of rows extending in a direction intersecting an extension direction of a boundary between the ground contact surface and the groove wall surface.
